(19) United States
(12) Patent Application Publication
(10) Pub. No.: US 2021/0316317 A1
(43) Pub. Date: Oct. 14, 2021

(54) DEVICES AND METHODS FOR PORTABLE AND COMPACT CENTRIFUGATION

(71) Applicant: Sandstone Diagnostics, Inc., Pleasanton, CA (US)

(72) Inventors: Ulrich Schaff, Livermore, CA (US); Angela Le, San Jose, CA (US); Tifany Pan, Walnut Creek, CA (US); Kyungjin Hong, Livermore, CA (US); Clara Neal, Livermore, CA (US)

(73) Assignee: Sandstone Diagnostics, Inc., Pleasanton, CA (US)

(21) Appl. No.: 17/229,460

(22) Filed: Apr. 13, 2021

Related U.S. Application Data
(60) Provisional application No. 63/009,467, filed on Apr. 14, 2020.

(51) Int. Cl. B04B 5/04; B04B 9/02; B04B 9/14; B04B 7/02

(52) U.S. Cl. CPC B04B 5/0414; B04B 9/02; B04B 2007/025; B04B 7/02; B04B 9/14

(57) ABSTRACT

Embodiments of a portable and compact centrifugal system are described, comprising a centrifuge body comprising a motor; and a monolithic rotor, suitable for manufacturing in a straight-pull injection mold, with an attachment hub, fixed retainer for exactly one sample tube, arms for the retainer, and a thin, aerodynamic counterweight. Embodiments include a rotor with a counterweight and wherein the tube retainer and the counterweight are angled downward; a central clearance volume for manual placement of a sample tube; and dimensions optimized to just fill a fixed rotational circle. Embodiments include a centrifuge with: an enclosure, hinged lid, lid-closure sensor, motor, and automatic timer; free of both user controls and user displays.

### BACKGROUND OF THE INVENTION

This invention is directed to an apparatus and methods of fluidic separation of particles suspended in a liquid supernatant. In particular, separation of whole blood into plasma and blood cell components, using a centrifugal system. Other biological samples containing cells or particulates may also be separated by such a centrifugal system. Prior art centrifugal devices require manual rotor balancing by a user.

Whole blood quickly deteriorates ex vivo, so it is typically processed within 24 hours of obtaining a sample. Whole blood may be separated into red blood cells, platelets, and plasma. Plasma has a shelf life of up to one year when frozen and can be subject to various analytical laboratory tests such as the comprehensive metabolic panel or lipid panel to determine attributes of a person's overall health or to assist in making clinical decisions. Another benefit of separating whole blood into a plasma part and cell part is that it prevents the diagnostic instrument clogging with blood cells. Plasma is more stable than whole blood because red blood cells may hemolyze and release their intracellular contents into the sample, which may interfere with analyte concentrations in diagnostic testing. Serum, which is the liquid left behind following the clotting of whole blood, may also undergo centrifugation with embodiments of this invention.

Prior art required trained users, which limits applications in the field, remote locations, vehicles, sand use by patients. This typically requires transportation from sample-collection to a testing site. This further limits application of prior art of time-sensitive applications. Some prior art includes hand-cranked centrifuges. These have problems including insufficient and inconsistent spin rate and spin time.

Prior art requires fluid-containing tubes for centrifugation to be in pairs in order to balance the centrifuge or spinning rotor. Preparing a second, matching tube requires training, skill, equipment and time.

Prior art requires a user to operate the centrifuge with a user interface, such as setting spin rate, spin time, and the like.

Prior art has two enclosures between the ambient air and the sample-containing tube For example, tubes may be placed inside a spinning “space-ship” enclosure, which in turn is inside a centrifuge case or primary enclosure.

### SUMMARY OF THE INVENTION

Embodiments of devices and methods of use are described that overcome limitations and weaknesses of the prior art of centrifuges.

In one embodiment, a centrifuge device is particularly small, light and inexpensive, enabled by specific structural features described herein, to enable use of the device in remote locations without the need for a trained user or power source. In some embodiments the entire device is disposable.

In another embodiment, a centrifuge device is free of a user interface comprising switches, knobs, buttons, display, and the like. Operation requires only placing a single sample tube into a corresponding receptacle and closing the lid. The centrifuge automatically starts, spins at an appropriate speed for an appropriate amount of time, then stops automatically. The user may then remove the sample tube now comprising separated portions of the sample. This embodiment is free of a start button and free of a stop button.

In yet another embodiment, the device comprises a single receptacle for exactly one sample tube. A rotor is pre-balanced with a fixed counterweight and counterweight location, freeing a user from any weight balancing and freeing the user from the need to prepare a second tube. Indeed, a user may not perform any weight balancing.

In yet another embodiment, the rotor is a single, injection moldable, monolithic component, including a motor hub, sample tube receptacle, and counterweight. Embodiments may also include aerodynamic “wings” to reduce spinning air resistance. In a variation of this embodiment the rotor is still a single monolithic element, however, this rotor comprises a receptacle to receive a counterweight, such as one or more steel shot balls. This counterweight element is typically factory-installed, so that a user needs no knowledge, training, are hardware for balancing the rotor. In some embodiments, the counterweight and aerodynamic wings are combined in a single portion of the rotor. Such embodiments may include a rotor design shape such that it can be injection molded in a single-shot, single pull mold.

In yet another embodiment, the rotor comprise one or more “arms” or “lips” as part of the sample tube receptacle that flexibly retain the single sample tube, by the use of friction or pressure from the arms against the sides of the sample tube. The sample tube is simply pressed in the receptacle by hand, then removed by hand by pulling it from the receptacle. The arms maintain the sample tube in a fixed position relative to the rotor. Arms may be implemented by a whole or partial “ring” around the neck of the tube, wherein the ring has one or more slots to permit a flexible, pressure fit around the sample tube.

In yet another embodiment, the receptacle in the rotor holds the sample tube at a fixed angle more than zero degrees (horizontal tube) and less than 90 degrees (vertical tube) from the plane of the rotor.

Embodiments include just the rotor.

Embodiments include the rotor and centrifuge housing, mechanics and electronics.

Embodiments include the use of a primary battery, sealed inside the centrifuge housing. This frees users from any consideration of a power source, either external or by the use of battery installation, or by the use of connection to a battery charging source.

Methods and devices for separating biological samples with a compact apparatus are described. Embodiments provide rotation of a single sample tube containing a biological sample, without balancing. Embodiments comprise a pre-balanced, compact, disposable rotor in a small, portable, sterilizable, self-contained housing. The devices conserve energy by lightweight construction and aerodynamic design, allowing powered operation with internal or external batteries or another portable and compact power source.

Embodiments enable remote blood separation, where access to plug-in centrifugation is limited, because embodiments are powered by a batteries or another portable power source. Without requiring an external power source, use of embodiments in remote environments, homes, or vehicles can be achieved. Internally powered centrifuge such as embodiments described herein provide the consistent spin rate and spin-time performance required by regulations and standards for diagnostic testing. Furthermore, balancing and operating a conventional centrifuge is not within the capability of most untrained users as may be common in remote, transportation or home environments. At-home or remote testing is facilitated by a small, portable, self-powered centrifuge. Such embodiments have a minimal size to facilitate portability, fitting within a typical pocket, backpack, purse, emergency kit, and the like. Embodiments include internal battery-powered operation, minimizing the diameter of the centrifuge rotor to facilitate portability, and self-balancing to eliminate the need for technically challenging balancing operations. Complete autonomous use by a user, care-giver or patient at home or in a remote medical outpost is therefore possible.

The embodiments described herein are generally intended to facilitate separation and processing of fluid samples in circumstances where prior art centrifuges are often insufficient or unavailable including: (a) processing samples between 0.02 mL and 2.00 mL in volume, (b) processing samples by untrained users, (c) processing samples in remote areas or without available power, (d) processing samples with limited shelf or storage space (e) processing samples under time pressure. Typically, such fluid samples are of a biological or medical nature, but not exclusively, and non-limiting.

### BRIEF DESCRIPTION OF THE FIGURES

FIG. 1A shows an enclosed one-tube rotor in a top view.

FIG. 1B shows an enclosed one-tube rotor in a cross-section view.

FIG. 2 shows an enclosed one-tube rotor in top view with a detached bottom part and assembly components.

FIG. 3 shows an enclosed one-tube rotor in a cross-section of assembly within a device.

FIG. 4A shows a top view of a press-fit rotor.

FIG. 4B shows a side view of a press-fit rotor.

FIG. 4C shows a cross-sectional view of a press-fit rotor.

FIG. 5 shows an angled press-fit rotor in a side view.

FIG. 6 shows an enclosed one-tube rotor in an alternate top view

FIG. 7A shows a first side view of an offset balance rotor.

FIG. 7B shows a second side view of an offset balance rotor.

FIG. 7C shows a top view of an offset balance rotor.

FIG. 8 shows an alternate press-fit rotor cross section.

FIG. 9A shows a perspective view of an alternate embodiment of the rotor.

FIG. 9B shows another perspective view of an alternate embodiment of the rotor.

FIG. 10 shows an embodiment of a centrifuge.

Brief descriptions of the figures are of exemplary embodiments, non-limiting.

### DETAILED DESCRIPTION OF THE INVENTION

The embodiments described herein generally include centrifugal devices intended to separate a heavy fraction from a light fraction in a fluid sample by rotation of a rotor at an effective spin rate. An example of such a fluid sample is a blood sample comprising plasma as the light fraction and blood cells as the heavy fraction. Such devices may also be used to separate serum from clotted whole blood. Embodiments are optimized for applications where portability is desirable. Therefore, elements are included that minimize energy consumption and size of the centrifugal devices. Furthermore, embodiments disclosed are configured or adapted to separate a fluid sample contained in a single tube or other container. Prior art centrifugal devices require rotor balancing by a user. By including appropriate counterweights, as well as other elements, embodiments herein described and claimed may not require field balancing by a user.

The major components of a centrifuge embodiment include: a case, a lid, a motor, and a rotor. The case holds any necessary electronics, the motor, and an integral power source, such as a primary battery. (Other embodiments use an external power source or rechargeable batteries.) The lid, typically transparent, operatively opens and closes, ideally with a fixed hinge to the case. When open, the rotor is exposed; a sample tube may be inserted or removed. When closed, the rotor and sample tube are isolated from the ambient air, and may be spun without the danger of interface from objects or hands. The motor comprises a motor shaft that spins when the motor is operating. The motor shaft is on and defines the axis of a device.

The rotor holds the sample tube, and by attachment to the motor shaft spins the sample tube centrifugally when the motor is operating. The rotor has a primary rotor plane, which is normal to the device axis. The axis of the centrifuge is also the spin axis of the rotor.

The rotor has three primary components. Note that in some embodiments the entire rotor is monolithic, and so a boundary between such rotor components is within the rotor and may not have “bright line” component boundaries. The primary rotor components are: a hub, a sample tube receptacle, and a counterweight. The hub attaches the rotor to the motor shaft. Ideally, this is a push-on, pull-off removable attachment, wherein typically friction maintains the rotor on the motor shaft when so placed. In embodiments with a single-use centrifuge, the rotor may be permanently attached to the motor shaft. The sample tube receptacle is adapted to removably receive a single, appropriate sample tube. Typically, “arms” or “lips,” as part of the monolithic rotor, hold the sample tube in place by a combination of friction and pressure between the receptacle and the sample tube. The counterweight, which may be part of the monolithically molded rotor, or may be a separate element, such as a steel shot ball, placed within an appropriate counterweight receptacle in the rotor. The counterweight is opposite the sample tube receptacle with respect to the rotor axis. It is adapted to optimally counterweight a typical sample tube, with a typical amount of sample, placed into the sample tube receptacle. A rotor may also comprise aerodynamic “wings” to reduce air resistance of the rotor when spinning. These aerodynamic wings may be part of the counterweight or counterweight receptacle. In general these wings should be as thin as possible while still having the necessary mass to achieve a weight-balanced operating (spinning) rotor. The wings comprise a leading edge, a trailing edge, and an average or maximum thickness.

The sample tube, in the sample tube receptacle of the rotor, is held at a fixed, predetermined angle with respect to the rotor plane.

We first describe embodiments of a rotor. Then, below, we describe a whole centrifuge device.

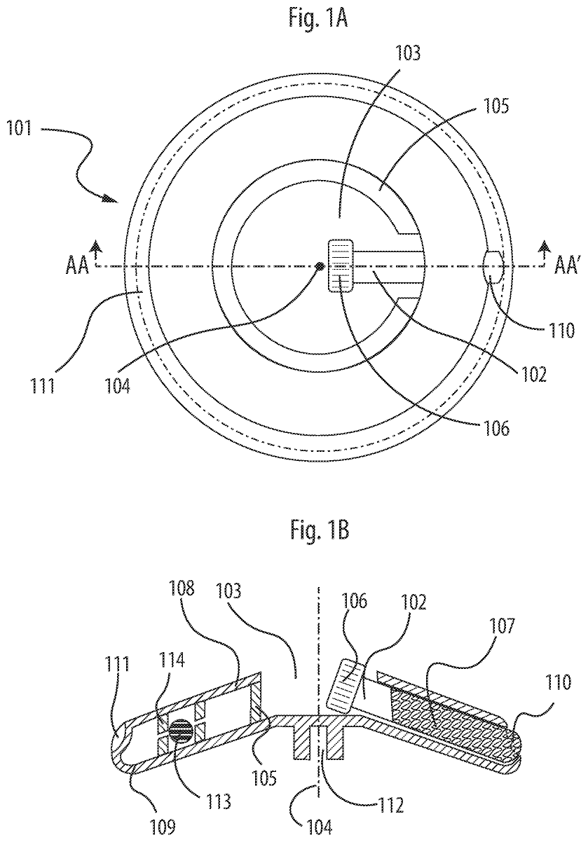

FIG. 1A shows an exemplary embodiment of a top view of an enclosed single-tube 102 holding an approximately disc-shaped rotor 101, which may comprise a distal hole 110 and a circumferential distal groove 111, wherein the sample tube 102 may be placed inside a central opening 103 within an inner wall 105 in such a way that a tube lid 106 may sit within one to 10 mm, or within one to five mm, of an axis of rotation, perpendicular to the page, 104. The reference rotor plane is parallel to the page, normal to the axis of rotation 104. In this way, the sample tube 102 will not swing outward as in prior art canonical swinging bucket rotors; it may be held at a fixed angle between, for example, 0 and 60 degrees inclusive, preferably between 0 to 45 degrees inclusive, with respect to a rotor plane. The bottom portion of the sample tube 102, where bottom is equivalent to a closed end lacking a lid, may protrude partially or wholly from the distal hole 110 to enable a rotor 101 with a reduced diameter. This element may be similarly copied to reduce the diameter on the opposite side of the approximately disc shaped-rotor in the distal groove 111. Minimizing the diameter of the rotor 101 may increase the portability of the product. Separation of a lighter fluid fraction from a heavier fluid fraction in a sample may be possible when the rotor is spun at an effective spin rate such as 2,000 to 15,000 RPM. Then, the sample tube 102 may be removed from the central opening 103 after spinning for supernatant extraction. The rotor 101 may comprise disposable materials so that it may be readily disposed of after use to reduce risk of biohazardous contamination. The rotor 101 may be designed for single use.

FIG. 1B shows an exemplary cross-sectional side view of the approximately disc-shaped rotor 10, at cross section AA-AA′, which comprises a top part 108, a bottom part 109, a hub 112, the distal hole 110, the distal groove 111, and a ballast enclosure or ribs 114 wherein a ballast 113 may serve as a counterweight to the sample tube 102 whose lid 106 sits about or near the axis of rotation 104 and may hold a fluid sample 107. The ballast enclosure 114 may comprise capture ribs to hold the ballast 113 in place during centrifugal rotation so that the center of mass of the rotor 101 assembly is within zero to five mm inclusive, preferably within a range of zero to one mm inclusive, of the axis of rotation 104. The ballast 113 may comprise one or more steel bearing balls, for example, of an exemplary size two mm to 12 mm in diameter. The ballast 113 may also comprise other materials such as lead, tungsten, copper alloys, aluminum alloys, glass, ceramic or other materials with mass density higher than 1.0 or higher than 1.5 grams per cubic centimeter. The inner wall 105 may prevent contact of interior portions of the rotor with biohazardous material of the fluid sample 107 from the sample tube 102 if the tube lid 106 is not attached properly. Note that, as shown in this figure, the tip of sample tube 102 projects through the distal hole 110. The distal hole 110 also serves to retain the sample tube 102. The hub 112 may allow the rotor 101 to mate with the motor pin of a motor of a centrifuge. Other embodiments do not have a ballast enclosure 114 or ballast 113, but rather have an effective counterweight molded as part of the rotor 101. The upper and lower portions 108 and 109 respectively, of rotor 101, may be approximately disk shaped, noting the inverted bowl shape as shown in FIG. 1B, and may comprise openings, slots, ridges, or other features within the nominal disk shape. The upper and lower portions 108 and 109 respectively, of rotor 101, may be constructed separately and assembled, or, preferably, manufactured as a single, monolithic elements, such as by injection molding the rotor 101. A preferred embodiment comprises a shape of the rotor 101 such that it may be molded in a single-shot, straight pull injection mold.

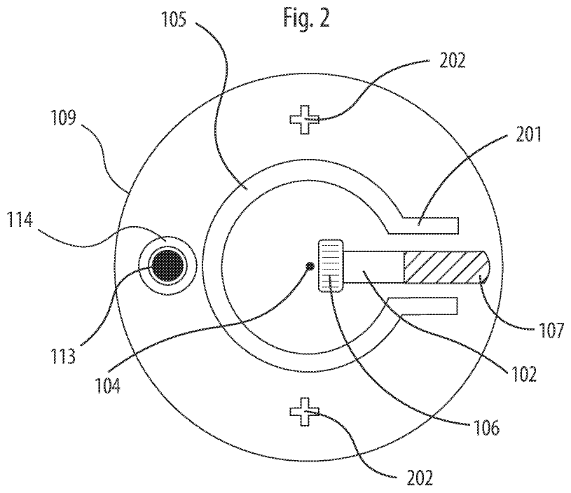

FIG. 2 relates to an embodiment wherein the rotor 101 is constructed from two portions, an upper portion 108 and a lower portion 109. shows an exemplary top view of the bottom part 109 of the rotor 101, wherein the sample tube 102 may be placed in the bottom part 109 of the embodiment of FIG. 1A with sidewalls 201 that border the sample tube 102 sides below the tube lid 106. This way, the sample tube 102 may easily be guided by the sidewalls 201 to slide into place for centrifugation. The ballast 113 is surrounded by the ballast enclosure 114 within the bottom part 109 opposite the location of the sample tube 102, so that a fluid sample 107 may be separated into lighter and heavier fractions when spun around the axis of rotation 104. The inner wall 105 of the bottom part 109 aligns with a matching inner wall 105 of the top part 108 when the attachment points 202 of the bottom part 109 are aligned and pressed into mated attachment points 202 on the top part 108. Other embodiments use a monolithic single part rotor 101, rather than a rotor with separate upper and lower parts 108 and 109 and mating points 202. Other embodiments use a counterweight molded into the monolithic rotor, rather than a separate “ballast” 113 within a ballast enclosure 114. Sidewalls 201 may be replaced by “arms” or “lips” for retention of a sample tube 102. In some embodiments the terms arms or lips apply to sidewalls 201.

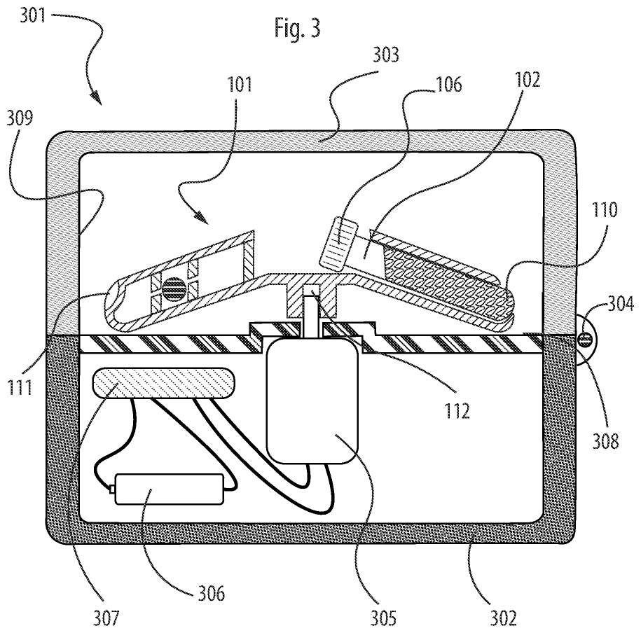

FIG. 3 shows an exemplary cross-sectional side view of a centrifuge 301 comprising a housing 302 which may include a hinge 304 enabling an operable lid 303 to open and revealing the rotor 101, adapted to holds sample tube 102 with the tube lid 106 above an internal top surface 308. The rotor 101, comprising the distal hole 110 and distal groove 111, is sufficiently compact to prevent interference with the lid 303 or housing 302 when spinning. When the operable lid 303, which may be within a clearance range of 0.1 mm to 10 mm inclusive, such as five mm, of the rotor 101. An electrical circuit or electronic controller provides power from a power source 306, such as a primary battery, to a motor 305. Electrical and electronic components may be on a circuit board 30. An internal power source 306 may comprise one or more lithium, alkaline, or nickel-metal hydride battery cells, as either primary or rechargeable batteries or other energy storage element, such as “super-capacitors.” Alternative embodiments support an external power source or external power to recharge rechargeable batteries. In one embodiment, a surface of the encloser 302 or lid 303 may comprise solar cells, which may be used to recharge an internal rechargeable power source. Rotation of the motor 305 mated to the hub 112 of the rotor 101 causes rotor 101 to rotate or spin, thus causing the sample fluid in sample tube 102 to undergo centrifugal separation. An effective rotation rate of the rotor 101 may be between 2,000 and 15,000 RPM inclusive and effective centrifugation time (a time at the effective rotation rate) may be minimized, while also minimizing cost, size, device complexity, and operation complexity while maximizing safety, simplicity, sanitation and reliability of the device. The housing 302 may comprise a vibration dampening material, functioning to decrease the vibration of the centrifuge to maintain sample purity and reduce audible noise. Examples of vibration dampening material include silicone rubber, thermoplastic elastomers, butyl rubber, and polydimethylsiloxane (PDMS). Placement of one or more vibration damping elements is well known in the mechanical arts. An inner surface 309 of the housing or lid may be disinfectable or sterilizable, such as by the use of sterilizing aerosols. Damping material and sealing materials may be used at various locations within an embodiment. For example, the circuit board 307, power source 306, motor 305 inner top surface 308, or lid 303, in any combination, may be isolated, mounted, or secured with a dampening material or gasket. Feet, not shown, under the enclosure 302 may also comprise a dampening material. The motor 305 may be a brushed or brushless motor. It may be a DC or AC motor, or a stepping or micro-stepping motor. A preferred motor may be a brushed DC motor.

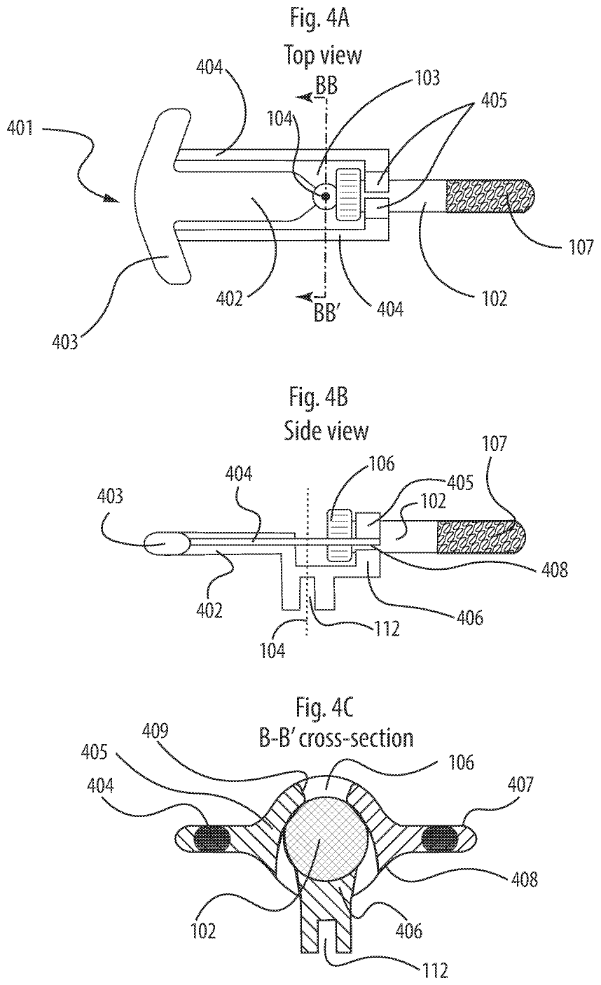

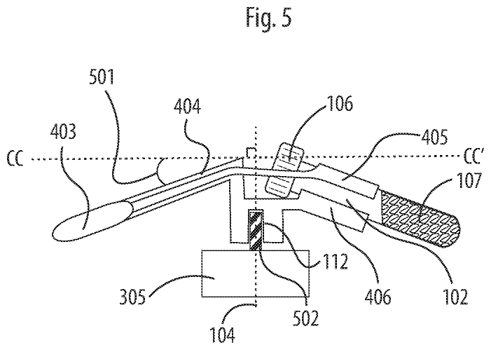

FIG. 4A shows a top view of an exemplary, unenclosed press-fit rotor 401 comprising a rotor body 402 and aerodynamic counterweight 403. The counterweight 403 compensates for the weight of the sample tube 102 and fluid sample 107 with respect to the axis 104. The counterweight 403 has a leading edge and a trailing edge (with respect to the direction of rotation of the rotor 401) to minimize air resistance. The counterweight 403 has generally smooth, curved surfaces to minimize air resistance. A counterweight support 402 connects the counterweight to the hub 112. Rotor 401 comprises “arms” 404 that connect from the counterweight 403 to hold or flexibly grasp the sample tube 102, near its neck, with clasps 405 and 406 partially surrounding the sample tube 102. The shape of the “arms” 402 may vary, so long as they flexibly grasp the sample tube 102 such that it may easily be properly placed and removed from the rotor 401. Clasps 405 and 406 may have an upper clasp and a lower claps as shown. However, clasps may vary in number and shape. For example, in other embodiments, clasps are formed from a ring with one or more slots, wherein the ring surrounds or partially surrounds the sample tube 102 at or near its neck. The clasps 405 and 406 flexibly and removably retain the sample tube 102 by any combination of friction and pressure. The sample tube 102 is manually placed through central opening 103. In the embodiment shown, the sample tube axis passes through the axis of rotation 104. The rotor 401 may comprise rubber, plastic, or other elastomeric materials for example, where the upper clasp 405 and lower clasp 406 (see FIG. 4B) contact the sample tube 102, to increase friction with the sample tube 102 and prevent it from shifting during operation; in particular, during starting and stopping rotation. In another embodiment, the rotor 401 may wrap around the tube lid 106 in order to prevent leakage of the fluid sample 107, in the case that the tube lid 106 were to detach, especially if the sample tube 102 were held in a horizontal or angled position. As shown in FIGS. 4A, 4B and 4C, the rotor 401 is generally planer, such plane shown as CC-CC′ in FIG. 15, normal to the axis of rotation 104. In other embodiments, the rotor 401 is angled downward from this plane, that is, “bent” near the central portion at or near the axis of rotation 104, such as shown in FIG. 5. In this embodiment the clasps 405 and 406 are angled such that the sample tube 102 is held at a fixed, predetermined downward angle from this plane. The counterweight 403 may or may not be similarly angled downward. The resulting angle of the sample tube 102 may be angled from one degree to 89 degrees, or an angle five degrees to 85 degrees, from 30 degrees to 60 degrees, or from 10 degrees to 60 degrees. A suitable angle is 45 degrees.

FIG. 4B shows an exemplary side view of the rotor 401 so that the hub 112 and lower clasp 406 of FIG. 4A may also be seen. Hub 112 may mate within a centrifugal device such as the centrifuge 301, or directly or indirectly to a motor shaft of motor 305 to rotate the rotor 401 around the axis of rotation 104.

FIG. 4C shows an exemplary cross-section of the rotor 401 at BB-BB′ (See FIG. 4A) comprising lead surface 407 with edges comprising an aerodynamic extension 408, and an entry surface 409. The entry surfaces 409 exemplify an opening where the sample tube 102 may be pressed into place between the two sides of the upper clasp 405 and the lower clasp 406 within the rotor 401. This way, the mid-section of the sample tube 102 is snap-fitted or press-fitted into the rotor, such that the tube lid 106 is behind (proximal to the axis of rotation 104) the upper clasp 405 and lower clasp 406, and the bottom end of the sample tube 102 may be seen centrally[US1]. The arms 404 may have a lead surface 407 protruding outwards from the sample tube 102 as part of the aerodynamic extension 408. Aerodynamic design with rounded, smooth edges may minimize air resistance against the rotor 401 during rotation. Rotor 401 will preferably be manufactured as a single, monolithic element, such as by injection molding the rotor 401. A preferred embodiment comprises a shape of the rotor 401 such that it may be molded in a single-shot, straight pull injection mold. For example, the upper clasp 405 may be shaped such that it does not overhang the lower clasp 406 at any point when viewed from above. Advantages of fabrication as a single, monolithic element by single-shot, straight pull injection mold include low cost and ease of production.

FIG. 5 shows an exemplary embodiment of the press-fit rotor 401, wherein the rotor 401 may be angled with respect to place CC-CC′, as shown by angle 501 Such angles are also shown in FIG. 3, in yet another embodiment. Otherwise similar components may comprise the rotor 401 such as counterweight 403 that may reach with arms 404 to hold the sample tube 102 with a tube lid 106 containing a fluid sample 107 by the upper clasp 405 and lower clasp 406 to mate at the hub 112 with a centrifuge 301 to rotate around the axis 104. This embodiment may decrease the overall diameter of the rotor 401 so that in combination with the appropriate centrifuge 301, a compact centrifugation system or device may be optimized for the factors described elsewhere herein. By tilting downward the sample tube 102, a smaller radius is swept by the sample tube, enabling a smaller footprint for an enclosing centrifuge device or system. Furthermore, the fluid sample 107 may be less likely to leak under gravitational force if the tube lid 106 is removed. Note for any shape of rotor 401, it is necessary to have clearance between elements such that the sample tube 102 may be manually placed into and removed from rotor 401, through a central opening 103.

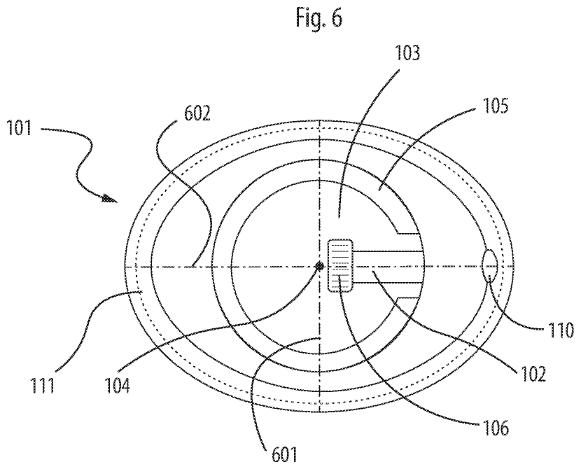

FIG. 6 shows an exemplary top view of an enclosed single-tube 102 holding disc-shaped sandwich-type rotor 101 embodiment similar to FIG. 1, wherein here a shorter semi-minor axis 601 and a longer semi-major axis 602 may create an oval or racetrack shape, rather than circular, disc, centered at the axis of rotation 104. In this way, materials, weight, and costs may be reduced compared with a nominally circular rotor as shown in FIG. 1. The rotor 101 may comprise the distal hole 110 in the circumferential distal groove 111, wherein the sample tube 102 with the tube lid 106 may be placed inside the central opening 103 and contained within the inner wall 105.

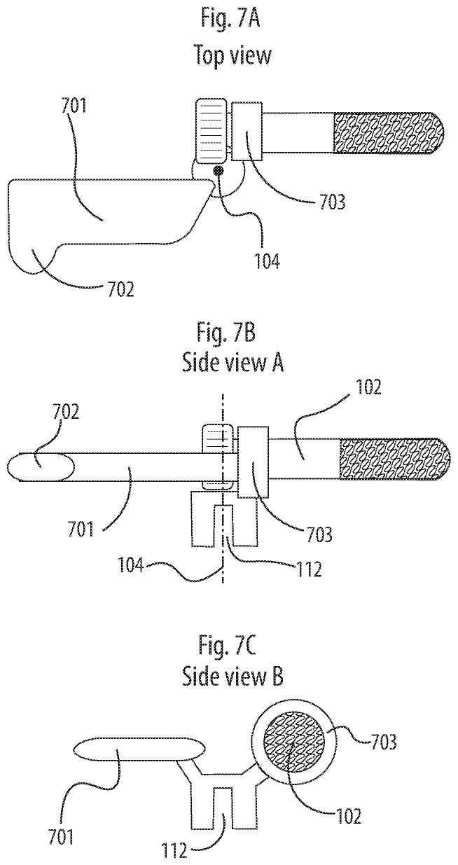

FIG. 7A shows a top view of yet another embodiment of rotor 101 the tube holder 703 may occupy a space reflected and offset from the arm 701 comprising a counterweight 702. The tube holder is offset from the counterweight 702 in a line perpendicular to the sample tube axis, wherein the counterweight may be oriented parallel to the tube axis, wherein the tube axis runs from the tube lid 106 through the fluid sample 107 to the bottom end of the sample tube 102.

FIG. 7B shows an exemplary side view A of the sample tube rotor 101 of an embodiment shown in FIG. 7A when looking upon a long side of the sample tube 102, so that the tube holder 703, arm 701 comprising a counterweight 702, and hub 112 centered at the axis of rotation 104 may be seen.

FIG. 7C shows a side view of the rotor 101 of an embodiment shown in FIGS. 7A and 7B. Shown is the bottom end of the sample tube 102 which is held by the tube holder 703 and connected to counterweight 701 through phalanges of the hub 112.

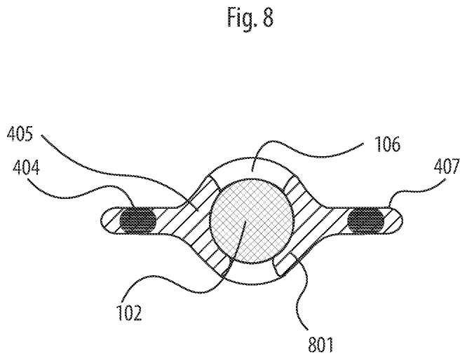

FIG. 8 shows an exemplary cross-section view of an embodiment of a press-fit rotor 401 wherein the upper clasp 405 and an optional or alternative lower clasp 801 may stem from the same part to hold the sample tube 102 on two opposing sides. The tube lid 106 lies behind the clasped region of the sample tube 102. The arms 404 may be contained within a lead surface 407 protruding outwards from the sample tube 102.

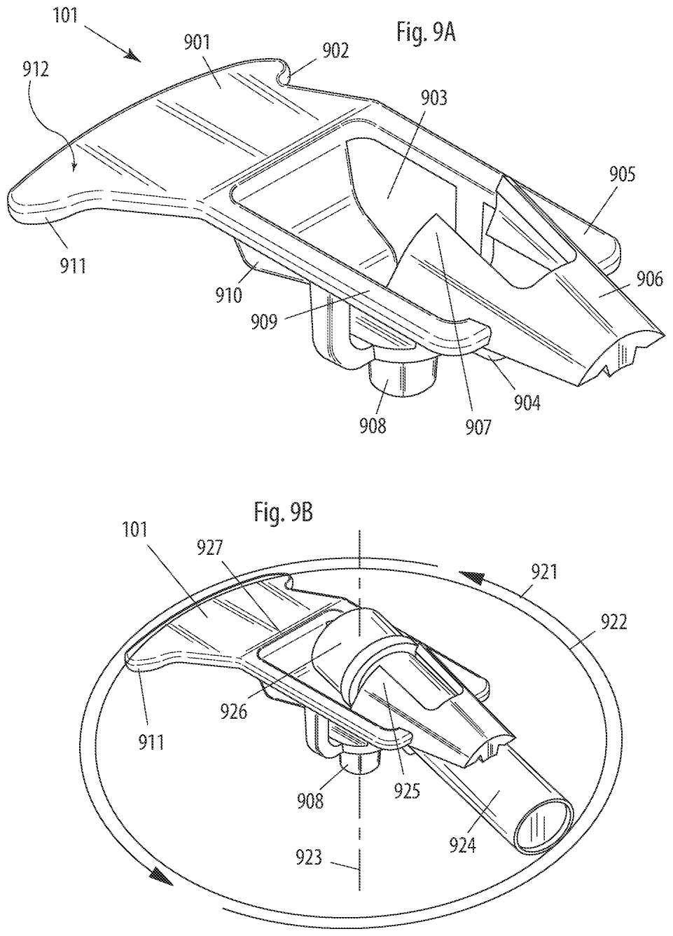

Referring now to FIGS. 9A and 9B, see perspective views of yet additional embodiments of a rotor. 101 shows the rotor. 901 shows a counterweight. Counterweights may have a significant number of embodiments; there may be more than one. They may be constructed as part of a monolithic rotor. They may comprise a separate ballast, such as one or more steel shot balls, or another dense material. They may be held in the rotor by rotor retention elements. It is advantageous that the counterweight be as aerodynamic as possible, to reduce air resistance, which in turn minimizes vibration and noise, and which also minimizes the size of a motor; minimizes a size of a power supply; maximizes the number of times a centrifuge may be run on a single internal power supply; and maximizes rotation speed, which in turn shortens the time required to centrifuge a fluid sample. A counterweight should generally be selected to optimally counterweight a typical sample tube filled with a typical amount and type of sample fluid. A counterweight may have a leading edge 911 which faces toward air as the rotor spins and a trailing edge 902 which faces away from air as the rotor spins. The leading edge 911 and trailing edge 902 are ideally designed, along with the shape and surface 912 of the counterweight to minimize air resistance, just like any wing or airfoil. Typically, an optimal shape for leading 911 and trailing 902 edges are not the same; however they may be. Counterweights 901 do not need to be symmetric and do not need to be located on an axis of a sample tube or sample tube retainer 906. A counterweight 901 may be angled downward from a rotor plane normal to the axis of rotation 923; however, it need not be angled downward; it may approximately level with the rotor plane or angled upward. Angling downward has several advantages, including making the overall diameter of the rotor smaller than a non-angled embodiment, and also more aerodynamic efficient. A downward angle of the counterweight may be similar to the downward angle of a sample tube 924. 903 shows an open volume in the rotor sufficient to permit manual insertion and removal of a sample tube 924 in a sample tube retention structure 906. This negative space (or volume) is somewhat difficult to represent within patent drawing requirements. This negative volume, in this embodiment, is defined roughly by the counterweight 901, a counterweight support structure 910, the sample tube retainer 906, and the hub 908. Note that the counterweight support 910 may have a somewhat non-intuitive shape specifically to create the necessary clearance as described for the sample tube 924.

906 shows one embodiment of a sample tube retainer. Such structural element or elements may have many different forms. The purpose of the sample tube retainer 906 is to removably hold a sample tube 924 during rotation, spin-up, spin-down, and manual insertion into and removal from the rotor 101. It is important that the sample tube 924 not shift or vibrate during such centrifuge operation. It may be held via friction and pressure from arms 905 and 909, and upper 907 and lower 904 portions of the sample tube retention structure 906. The sample tube retention structure 906 may have numerous embodiments, such as fingers, a ring, or a split ring, as a few forms; it may have a support or stop for a sample tube lid 926 or a support or stop for a distal end of sample tube 924; it may be tapered or non-tapered. Note that, as shown in this embodiment, the upper portion 907 (analogous to the upper clasp 405 associated with FIG. 4) and lower portion 904 (analogous to the lower clasp 406 associated with FIG. 4) partially wrap around the body of sample tube 924. The sample tube support 906 may be symmetric or non-symmetric; it is shown in these Figures as symmetric. Arms 905 and 909 may also have many forms. They are flexible to provide elastic pressure against an inserted sample tube 924 to assist in retention; however, such pressure is not a requirement in all embodiments.

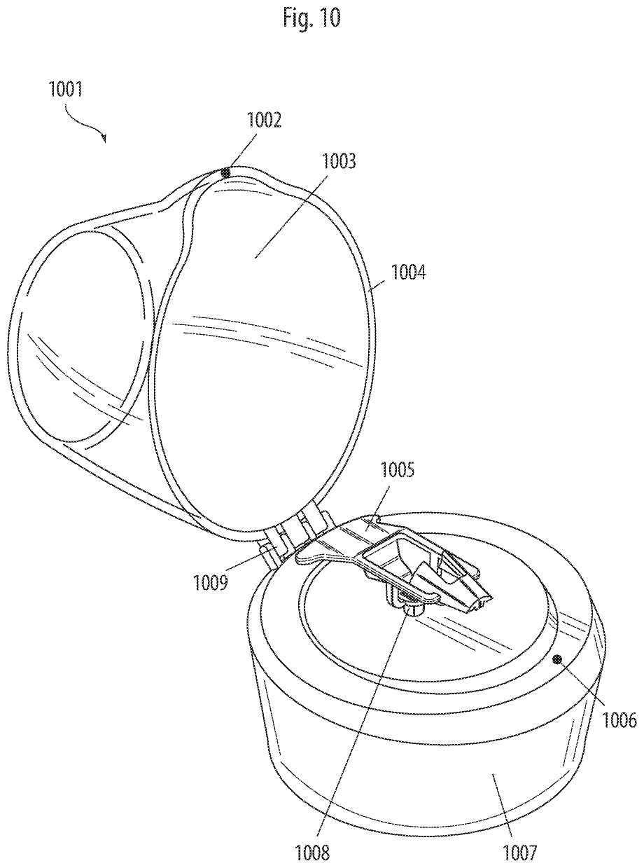

908 shows a hub portion of rotor 101. The hub 908 is used to removably attach, directly or indirectly, the rotor 101 to a centrifuge motor shaft, not shown. See also FIG. 10. In some embodiment, the attachment via 908 is not removable. Rotors 101 may be single use; or, they may be removed for sterilization. Hub 908 may attach to a motor shaft via a friction press-fit or a snap fit. It may comprise internal ridges (not shown) or a protrusion (not shown) to assist in a rigid mating to the motor shaft; this is particularly important during spin-up and spin-down. 912 shows an upper surface of the counterweight 901. This surface should be smooth to optimize aerodynamic efficiency. It may, however, be curved, like the surface of most wings, for this same purpose. A lower surface, not shown, of the counterweight 901 has similar requirement to the upper surface 912. It may or may be parallel to the upper surface 912, similar to the structure of most wings. Aerodynamic efficiency of rotor 101 and counterweight 901 design may be done via simulation software, or by testing on a centrifuge, or in a wind tunnel. In a simple method of optimization and testing, various designs may be tested in a centrifuge. If all else is comparable, the design with the fastest final spin speed, or the least vibration, or the least noise, is often the most optimal available design among those designs tested. It also desirable that the counterweight 901 minimize the manufacturing cost of the rotor, such as by permitting a single shot, straight-pull injection mold, minimizing material, and minimizing the maximum distance of any rotor 101 structure distal from the axis of rotations 923, such as the diameter of the rotor 101. One advantage of angling the counterweight 901 downward from a rotor plane orthogonal to the axis of rotation 923 is to minimize the overall diameter of the rotor 101 and thus also allow the size, weight and cost to be minimized.

Referring now to FIG. 9b, we see the same rotor 101 as in FIG. 9A. 921 shows a direction of rotation. Although typically a rotor may spin in either direction, if the leading edge 911 trailing edge 902 are not symmetric shapes, then direction of rotation is important. 922 shows a spin circle that represents the maximum diameter of any portion of rotor 101 and sample tube 924 when spinning. It is advantageous that this circle be as small as possible to minimize power, size, weight, and convenience of the rotor 101 and an associate centrifuge 1007 (See FIG. 10). Note that the outermost edge of counterweight 901 is curved to match the spin circle 922. 923 shows an axis of rotation; this axis passes through the center of hub 908. Note that hub 908 need not be symmetric. FIG. 9b also shows an installed sample tube 924 in the sample tube retainer 906. In this embodiment, the distal end of the sample tube 924 extends distally from the sample tube retainer 906. Further, the sample tube top and cap 926 extend proximally towards, or even past the axis 923 centerline. An advantage of his arrangement is to minimize the size of spin circle 922, which the distal end of the sample tube 924 must clear. Indeed, the length of sample tube 924 may be a major determinator for minimizing the size of the spin circle 922. In this embodiment the sample tube 924 and sample tube retainer 906 are angled downward from a rotor plane normal to the axis 923. Similar to the angling downward of the counterweight 901, this arrangement may minimize the size of the spin circle 922, with concomitant advantages as described herein. Another advantage of angling the sample tube 924 downward is that any sample fluid in the sample tube 924 is less likely to spill, in the event that the sample tube cap 926 is not fully secure on the sample tube 924. 927 shows an optional structural line between the counterweight 901 and the rest of the rotor 101 structure. The counterweight 901 and the arms 905 and 909 may angle downward from this line 927. However, any angling downward of rotor 101 elements is not necessarily from this or any other line. FIGS. 9A and 9B show rotor 101 with curved edges. Such curved edges assist in maximining aerodynamic efficiency or the rotor 101, and improve manual handling, and improve manufacturability and reduce total weight of the rotor 101. Such curved edges are not a requirement. Further, any such curvature may vary considerably at different portions of the rotor 101. FIG. 9B shows an upper portion 925 of sample tube retainer 906. Although this same structure is shown in FIG. 9A as 907, it is easier to see in FIG. 9B that element 925 assists, in conjunction with lower retainer element 904, in holding sample tube 924 in place. Sample tube retention elements 904 and 925 are “left and right” of sample tube 924, as compared to top and bottom, because rotational acceleration of sample tube 924 is higher during spin-up and spin-down that acceleration forces in the vertical direction (that is, parallel to axis 923. As an obvious comment, centrifugal forces on sample tube 924 away from the axis 923 are considerable; the overall design of rotor 101 must withstand these considerable forces and hold sample tube 924 securely in place during spin-up, spin-down and rotation, while still permitting easy, manual, insertion of the sample tube 924 into and removal from the rotor 101.

FIG. 10 shows an embodiment of a centrifuge 1001, suitable for spinning rotor 1005. The centrifuge comprises an enclosed base 1007, a clear lid 1003, on a hinge 1009. The lid 1004 is open during insertion into and removal of rotor 1005 from a motor shaft, not shown, that passes into hub 1008. Lid 1004 is closed during operation of the centrifuge. Lid lip 1004 provides a nominal seal against the base 1007, when closed. A gasket may be used to assist in sealing, which can reduce noise, reduce vibration, and protect against damage or injury in cases of failure. In one embodiment the state of the lid 1003, as open or closed, is detected by a magnet or other trigger 1002 placed in or on the lid 1003. This magnet or other trigger may be detected by a sensor 1006 placed external or internal to the base 1007. This feature enables completely automatic operation of the centrifuge. The centrifuge starts spinning automatically when the lid 1003 is closed, and continues spinning for a predetermined time interval or until the lid 1003 is opened. Embodiments of the centrifuge 1001 are free of any user controls, such as buttons, switches, a touch display, or wireless operation from a remote control app or panel. Embodiments of the centrifuge 1001 are free of any user display, such as visual indicators, visual display, or wireless display from a remote control app or panel. Embodiments of the centrifuge 1001 are free of any audible indicators, although audible indicators, such as spin done, or error, may still be in embodiments that are free of user controls and/or free of visual indicators. Embodiments may be free of attached user controls, attached visual indicators, or free of attached audible indicators, in any combination, that still optionally use a wireless app, such as a smart phone application, internet-based application or cloud-based application. Wireless connectivity may be via Wi-Fi, Bluetooth, cellular data, Near Filed Communication (NFC), infrared signaling, or other wireless communication.

Size of small sample tubes is not standardized. A typical tube may be 50 mm in length. Typical tube volume, for fluid samples, is in the range of 50 μL to 1000 μL. Another suitable range is 200 μL to 800 μL For the purpose of selecting a counterbalance weight, a tube may be considered to be in the range of 25% to 100% of capacity. Another suitable range is 60% to 80% of capacity. Typical rotor diameter may be in the range of 20 mm to 160 mm, or in the range of 50 mm to 100 mm. Suitable materials for the rotor include polymers such as PP, PC, PET, ABS, POM, PS, glass filled resin, nylon, Kevlar, carbon fiber composite. POM or ABS are preferred. Polymer should have relatively high stiffness (elastic modulus greater than 1.5 GPa) and density greater than one gram per cc.

Any counterweight or counterweight holder comprises smooth, curved surfaces to minimize air resistance during rotation operation, and to minimize cost of manufacturing the rotor 101. Further, embodiment shapes may permit manufacturing a monolithic rotor in a single step using a straight-pull injection mold. The radius of angles of a rotor 101 may be in the range of 0.1 mm to 3.0 mm, or in the range of 0.3 mm to 1.0 mm. These radii do not include the general shape of sample tube holders such as seen in FIGS. 4C, 5 and 8 or the outer surface of the counterweight or rotor from a top view such as shown in FIGS. 1A, 2, 4A and 6.

In yet another embodiment, a counterweight of rotor 101 may comprise aerodynamic structural features: a wider distal section and a narrower proximal section; a thicker distal section; wherein the counterweight is further configured for low aerodynamic drag by further comprising tapered leading and trailing surfaces with respect to a direction of rotation; wherein the tapered leading and trailing portions are at least one mm in length.

In yet another embodiment, a structural shape of rotor 101 comprises elements making it suitable for manufacturing using a straight-pull injection mold: the arms, rotor body, and upper and lower clasps are positioned such that when viewed from above, no upper surface of the arms, rotor body, upper and lower clasps overlap or occlude one-another; the arms, upper and lower claps are further positioned such that no lower surface of the arms, upper and lower clasps overlap or occlude one-another when viewed from below. Note for any shape of rotor, it is necessary to have clearance between elements such that the sample tube 102 may be manually placed into and removed from the rotor, such as through a central opening 103.

In yet another embodiment, upper and lower clasps to hold sample tube 102 have proximal surfaces that are perpendicular to the angle of the tube; the proximal surfaces are positioned to support one or more flange at the neck of the tube; the proximal surfaces further comprising a taper such that a diameter of the tube is larger than the distance between a portion of proximal surfaces on the upper clasp and a portion of proximal surfaces on the lower clasp. In some embodiments when the sample tube 102 is not placed in the rotor, the opening formed by the upper and lower clasps or other structure to retain a placed sample tube 102 is slightly less than the diameter of sample tube 102, wherein when sample tube 102 is placed in the rotor such clasps or other structure flex outward, thus providing pressure against the sample tube 102. Such pressure is suitable for manual placement and removal of the sample tube 102 from the rotor 101, while maintaining the sample tube 102 in a fixed position during operation.

### Additional Embodiments

Embodiments below and their equivalents, in any combination of features and limitations, are specifically claimed:
A. An apparatus embodiment comprising:
   a rotor assembly, an axis of rotation, a housing, a motor, a set of batteries, and a centrifuge lid; the centrifuge lid positioned over the rotor; wherein the set of batteries provides power to the motor that spins the rotor apparatus;
   the rotor assembly comprising a top part, a bottom part, a ballast, a sample tube containing a fluid sample, and a tube lid, the rotor assembly configured or adapted to rotate one tube only, wherein the sample tube is held at a fixed angle between 0 and 20 degrees with respect to a plane perpendicular to the axis of rotation; the rotor assembly having an entrance hole in the top part configured or adapted to allow the sample tube to be placed reversibly in the rotor assembly; the rotor assembly having an aerodynamic cross section; the rotor having a mating hub that connects to the motor at the axis of rotation; the tube lid positioned within the rotor assembly such that the tube lid is within 5 mm of the axis of rotation; said rotor assembly having an outer edge; said ballast being held on the opposite side of the axis of rotation from the tube by capture ribs; said ballast being placed such that a center of mass of the rotor assembly is within 2 mm of the axis of rotation.
B. The apparatus of embodiment A further comprising a distal hole that allows a bottom portion of the sample tube to protrude from the edge of the rotor assembly.
C. The apparatus of embodiment A further comprising a circumferential groove in the top part; the circumferential groove reducing the diameter of said rotor.
D. The apparatus of embodiment A wherein the centrifuge lid is within 1.5 mm of said rotor edge.
E. The apparatus of embodiment A, wherein said rotor apparatus comprises a longer axis and shorter axis, having lead surface edges with aerodynamic extensions; wherein the ballast and the sample tube is located along the long axis.
F. The apparatus of embodiment A wherein said ballast comprises one or more steel bearing balls.
G. The apparatus of embodiment A wherein said housing comprises a vibration dampening material.
H. An apparatus embodiment comprising:
   a rotor, a sample tube, a tube lid, a fluid sample contained within the sample tube, an axis of rotation, a housing, a motor, a set of batteries, and a centrifuge lid; the centrifuge lid positioned over the rotor; wherein the set of batteries provides power to the motor that spins the rotor apparatus;
   wherein the rotor comprises one monolithic part, the rotor configured or adapted to rotate one tube only; said rotor comprising an axis of rotation;
   wherein the sample tube is held at a fixed angle between 0 and 20 degrees with respect to a plane perpendicular to the axis of rotation; wherein said motor mates with said rotor at a hub located at said axis of rotation; said rotor further comprising a body and a counterweight with an aerodynamic cross section;
   wherein the counterweight being structure such that a center of mass of the rotor assembly is within two mm of the axis of rotation; the tube lid positioned within the rotor such that the tube lid is within 5 mm of the axis of rotation; said
   rotor further comprising arms and upper clasps; said upper clasps holding the sample tube securely when the rotor is rotated at an effective rate; said arms and top clasps having aerodynamic surfaces; said upper clasps having entry surfaces.
I. The apparatus of embodiment H, wherein the upper clasps are joined to said counterweight by said arms; said projections being configured or adapted to flex apart when a sample tube is inserted from above; wherein multiple bore tubes may be accommodated.
J. The apparatus of embodiment H further comprising aerodynamic extensions.
K. The apparatus of embodiment H further comprising lower clasps extended from the hub or from the upper clasps.
L. An apparatus embodiment comprising:
   a rotor, a tube, a tube lid, a fluid sample contained within the tube, an axis of rotation, a housing, a motor, a set of batteries, and a centrifuge lid; the centrifuge lid positioned over the rotor; wherein the set of batteries provides power to the motor that spins the rotor apparatus;
   wherein the rotor comprises one monolithic part, the rotor configured or adapted to rotate one tube only; said rotor comprising an axis of rotation and a tube axis; wherein the sample tube is held at a fixed angle between 0 and 20 degrees inclusive with respect to a plane perpendicular to the axis of rotation;
   wherein the centerline of the tube is placed parallel with the tube axis; wherein
   said motor mates with said rotor at a hub located at said axis of rotation; said
   rotor further comprising a counterweight with an aerodynamic cross section;
   the rotor comprising a ring shaped tube holder offset from the counterweight in a line perpendicular to the tube axis; said counterweight being oriented parallel to the tube axis; Said counterweight having an aerodynamic cross-section less than half the cross-section of the sample tube.

Embodiments below and their equivalents, in any combination of features and limitations, are specifically claimed:
M. A centrifuge comprising:
   a rotor comprising a sample tube retainer;
   a motor with an motor shaft and an axis of rotation;
   an enclosure comprising the motor, an power source, and a rotation timer;
   a lid;
   a sensor adapted to detect the state of the lid as open or closed;
   wherein the rotation of the rotor starts and the timer is started when the lid is closed and stops when the first of either the lid is opened or the timer expires.
N. The centrifuge of embodiment M, wherein:
   the centrifuge is free of user controls, free of visual user displays, and free of attached wires.
O. The centrifuge of embodiments A through L, wherein
   the centrifuge is free of a wireless data interface.
P. The centrifuge or rotor of any above embodiments wherein:
   neither the centrifuge nor the rotor require any balancing.
Q. The centrifuge or rotor of any above embodiments wherein:
   effective use is free of tools.

Descriptions, scenarios, examples and drawings are non-limiting embodiments. All references to “invention” or “variation” refer to “embodiments.”

Embodiments described herein are of a device intended for use in blood separation, and methods of using the device. Other embodiments have other applications.

Drawings are not to scale.

The terms, “device” and “apparatus” are equivalent and interchangeable. Unless otherwise stated, or clear from the context. A “device” is either a centrifuge or a rotor for a centrifuge. The terms “rotate” and “spin” are equivalent and interchangeable. The terms “counterweight” and “counterbalance” are equivalent and interchangeable.

Ideal, Ideally, Optimum and Preferred—Use of the words, “ideal,” “ideally,” “optimum,” “optimum,” “should” and “preferred,” when used in the context of describing this invention, refer specifically to a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates. The phrase, “configured to” also means, “adapted to.” The phrase, “a configuration,” means, “an embodiment.”

All numerical ranges in the specification are non-limiting exemplary embodiments only. Brief descriptions of the Figures are non-limiting exemplary embodiments only.

Embodiments of this invention explicitly include all combinations and sub-combinations of all features, elements and limitations of all claims. Embodiments of this invention explicitly include all combinations and sub-combinations of all features, elements, examples, embodiments, tables, values, ranges, and drawings in the specification, Figures, drawings, and all drawing sheets. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substitution thereof to any and all other device claims, including all combinations of elements in device claims.

We claim:

1. A centrifuge comprising:
an enclosure, comprising internally:
a motor with a motor shaft aligned on a rotation axis;
a power source;
a rotation timer;
a lid-closure sensor;
wherein the centrifuge further comprises:
a lid with a hinge attached to the enclosure;
a rotor comprising:
a rotor plane, normal to the rotation axis;
a motor attachment hub, adapted to be attached to the motor shaft
exactly one tube retainer adapted to manually, removably hold exactly a single, fluid sample tube at a fixed, predetermined angle from the rotor plane;
a counterweight adapted to counterbalance the rotor when rotating with the single, fluid sample tube; and
an open, central portion adapted manually pass through the single, fluid sample tube into the single tube retainer.

2. The centrifuge of claim 1, wherein:
the rotor is monolithic.

3. The centrifuge of claim 1, wherein:
the centrifuge is free of user controls and free of user displays.

4. The centrifuge of claim 1, wherein:
the centrifuge is free of attached wires.

5. The centrifuge of claim 4, wherein:
the centrifuge is free of a wireless data interface.

6. The centrifuge of claim 1, wherein:
the centrifuge starts rotation of the rotor automatically when the lid is closed; and
wherein the rotation timer starts automatically when the lid is closed.

7. The centrifuge of claim 1, wherein:
the centrifuge stops rotation of the rotor automatically the earlier of: (i) when the rotation timer expires, or, (ii) when the lid is opened.

8. The centrifuge of claim 1, wherein:
the tube retainer further comprises an upper portion and a lower portion;
wherein the one or more support arms connect to the upper portion and the motor attachment hub connects to the lower portion.

9. The centrifuge of claim 1, wherein:
the rotor further comprises: a curved or angled counterweight support structure mechanically connecting the motor attachment hub to the counterweight wherein a shape of the counterweight support structure is free of interference with the open central portion.

10. The centrifuge of claim 1, wherein:
the counterweight comprises a leading edge and a trailing edge, wherein the leading edge and trailing edges are adapted, along with the remainder of the counterweight, to minimize air resistance when the rotor is spinning.

11. The centrifuge of claim 1, wherein:
the rotor is free of moving parts, other than an elasticity of a material of which the rotor is fabricated.

12. The centrifuge of claim 1, further comprising:
a vibration damping motor mount.

13. A method of use of a centrifuge wherein:
the centrifuge comprises an enclosure, comprising internally:
a motor with a motor shaft aligned on a rotation axis;
a power source;
a rotation timer;
a lid-closure sensor;
wherein the centrifuge further comprises:
a lid with a hinge attached to the enclosure;
a rotor comprising:
a rotor plane, normal to the rotation axis;
a motor attachment hub, adapted to be attached to the motor shaft exactly one tube retainer adapted to manually, removably hold exactly
a single, fluid sample tube at a fixed, predetermined angle from the rotor plane;
a counterweight adapted to counterbalance the rotor when rotating with the single, fluid sample tube; and
an open, central portion adapted manually pass through the single, fluid sample tube into the single tube retainer;
comprising the steps:
placing manually a sample tube comprising a sample fluid into the rotor;
closing manually the lid;
spinning automatically the rotor; and
removing manually the sample tube after the centrifuge has stopped spinning.

14. The method of claim 13, wherein:
placing and removing the sample tube is manual and free of tools.

15. The method of claim 13, wherein:
the centrifuge is free of visual user controls, free of user displays, free of connecting wires, and free of a wireless data interface.

16. The method of claim 13, wherein:
the method steps are free of a user activating a start of spinning of the rotor, other than closing the lid.

17. The method of claim 13, wherein:
the method steps are free of a user activating a stop of spinning of the rotor.

18. The method of claim 13, wherein:
the method steps are free of tools.

19. The method of claim 13, wherein:
the method steps are free manual balancing of the rotor.

20. The method of claim 13, wherein:
the fluid sample tube length is less than or equal to 50 mm and the fluid sample volume is in the range of 20 μL to 1000 μL.
